(19) United States
(12) Patent Application Publication
(10) Pub. No.: US 2025/0139782 A1
(43) Pub. Date: May 1, 2025

(54) IMAGE CROPPING USING ANCHOR SHAPES

(71) Applicant: Beijing YoJaJa Software Technology Development Co., Ltd., Beijing (CN)

(72) Inventors: Shuai Lou, Beijing (CN); Kui Wang, Beijing (CN); Gang Wang, Beijing (CN); Morgan Cheng, Beijing (CN)

(73) Assignee: Beijing YoJaJa Software Technology Development Co., Ltd., Beijing (CN)

(21) Appl. No.: 18/517,437

(22) Filed: Nov. 22, 2023

Related U.S. Application Data
(63) Continuation of application No. PCT/CN2023/126670, filed on Oct. 26, 2023.

(51) Int. Cl. G06T 7/12; G06V 10/25; G06V 10/771

(52) U.S. Cl. CPC G06T 7/12; G06V 10/25; G06V 10/771; G06T 2207/20132

(57) ABSTRACT

In some embodiments, an image is received. The method includes analyzing the image based on a plurality of anchor shapes to generate respective outputs for anchor shapes in the plurality of anchor shapes. The output rates a cropping of the image using a respective anchor shape. The method analyzes respective outputs for the anchor shapes in the plurality of anchor shapes to select an anchor shape. The image is cropped using the anchor shape.

### CROSS REFERENCE TO RELATED APPLICATIONS

This application is a continuation application and, pursuant to 35 U.S.C. § 120, is entitled to and claims the benefit of earlier filed application PCT App. No. PCT/CN2023/126670, filed Oct. 26, 2023, entitled “IMAGE CROPPING USING ANCHOR SHAPES”, the content of which is incorporated herein by reference in its entirety for all purposes.

### BACKGROUND

Image cropping is a technique to remove a part of an image to adjust the size or aspect ratio of the image. Image cropping may also be used to improve an aesthetic quality of the image by removing parts of the image that may not be considered necessary. However, determining the part to remove may be a highly subjective task because it is dependent on the aesthetic standard of respective human beings.

An image cropping process may attempt to automate the cropping of images. However, when automating the image cropping process, the result may not always be optimal in the view of the aesthetic standard of various human beings. Additionally, large amounts of training data may be necessary to train a model that performs the cropping of images. For example, models may be trained to predict coordinates of bounding boxes to crop the image. This type of prediction requires large amounts of training data to train the model on a large variety of images. Also, a large amount of computing resources may be needed to train the model. When the resources are not available to train the model, the cropping of the images may be sub-optimal.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 depicts a simplified system for cropping images according to some embodiments.

FIG. 2 depicts an example of a set of anchor boxes according to some embodiments.

FIG. 3 depicts an example of using a metric to generate scores for anchor boxes according to some embodiments.

FIG. 4 depicts an image cropping system for training a model for generating scores according to some embodiments.

FIG. 5 depicts a simplified flow chart of a method for training a model to generate scores and offset coordinates according to some embodiments.

FIG. 6 depicts the image cropping system for cropping an image according to some embodiments.

FIG. 7 depicts a simplified flow chart of a method for cropping an image according to some embodiments.

FIG. 8 depicts an example of the image cropping system for generating scores and offset coordinates according to some embodiments.

FIG. 9 depicts a video streaming system in communication with multiple client devices via one or more communication networks according to one embodiment.

FIG. 10 depicts a diagrammatic view of an apparatus for viewing video content and advertisements.

### DETAILED DESCRIPTION

Described herein are techniques for a video processing system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### Overview

A system crops an image to generate a cropped image using a set of anchor boxes to determine where to crop the image. Anchor boxes may be a set of predefined shapes that are used to predict potential areas to crop the image. Anchor boxes may be different shapes depending on the desired area that should be cropped. Although a “box” is used in the element “anchor box”, an anchor box may be shapes other than boxes. In some examples, anchor boxes are square shaped, but other anchor shapes such as rectangular, oval, circular, etc. may be used. Anchor boxes may be used for discussion purposes, but any anchor shapes may be used. A prediction network may generate a score for respective anchor boxes based on the input image. The score may rank respective anchor boxes based on using the anchor box to crop the image. In some embodiments, the score may be based on a metric of intersection over union (IoU). The intersection over union metric may measure the overlap of the anchor box and a ground truth of the labeled box. The ground truth may be based on the labels that are used to train a model, and represent the location of the preferred cropping of an image. In some embodiments, the training of a model of the prediction network may compare a generated score by the model and a ground truth score that is based on an overlap of the anchor box and a labeled box (e.g., ground truth) to crop of the image. Parameters of the model are adjusted such that the score generated by the model is adjusted to be closer to the ground truth score. Once trained, the model may output scores based on the input image.

To crop an image, the system may output scores for respective anchor boxes that rank anchor boxes based on analyzing an image. In some embodiments, the scores may predict an overlap of the anchor box with a hypothetical bounding box, which may be a preferred cropping of the image. The hypothetical labeled box may not be known in the prediction, but the system was trained using ground truth labeled boxes to predict the scores. The scores may be quality scores that rate the cropped image that results from cropping the image using the respective anchor box. When the system is not in the training process, the prediction network predicts the score based on its training of the parameters. The highest ranked score for an anchor box may be selected. Then, the system uses the anchor box to crop the image. In some embodiments, the system may crop the image based on coordinates of the anchor box. In other embodiments, the prediction network may output offset coordinates for the anchor box. The system uses the offset coordinates to adjust which area is cropped in the image based on the anchor box. In this case, the system may use the offset values to crop the image with adjusted coordinates from the selected anchor box.

The use of anchor boxes provide many advantages. For example, fewer computing resources may be used, such as processing power to train the model or generate predictions. The prediction network may analyze content from the image that is within the anchor box to determine the score. Thus, the prediction network may be analyzing less information compared to analyzing the entire image, which uses fewer computing resources. Also, the training data set that is required to train the model of the prediction network may be smaller. For example, the training of the prediction network to generate scores based on the metric may require less training data and less time in adjusting parameters to converge to the final parameters to use compared to a prediction network that is trained to output coordinates of a bounding box for the cropping. This is because training a prediction network to output the coordinates of a bounding box may require large and diverse examples of different images. Also, by predicting the coordinates directly, the potential results space would be composed with every single box within the image area. The results space may be the potential outputs of the prediction network. This could be a very large set. For example, given an image with 1024×768 resolution, the number of potential result boxes is (pixel number) \hat{ }2/2=(1024*768)*(1024*768)/2=309237645312. But on the other hand, a results space for a limited number of anchor boxes is much smaller because the prediction network needs to evaluate and predict the results within the anchor boxes. A smaller results space may result in the prediction network being easier to train with a smaller training dataset, which uses less processing power. In some embodiments, the system may not have access to large amounts of training data. For example, a video delivery system may want to crop images that are being used on its interface. However, the system may have a limited number of examples of instances of content that have been cropped, which limits the number of images that can be used in the training data set. Predicting the coordinates of the bounding box directly may require more images in the training dataset than the system could provide, which may result in prediction networks that are sub-optimal.

### System

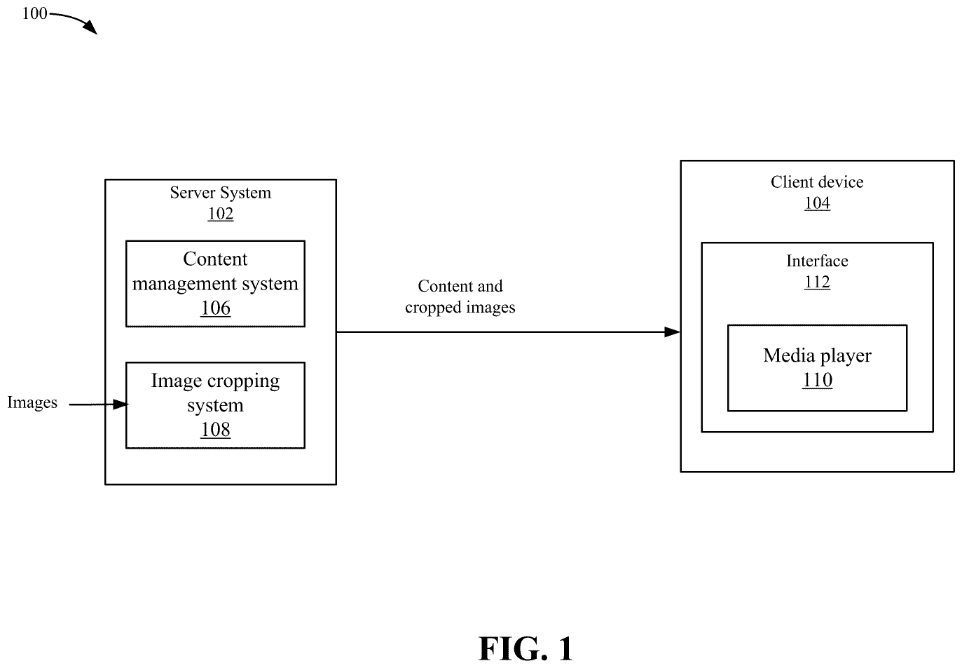

FIG. 1 depicts a simplified system 100 for cropping images according to some embodiments. System 100 includes a server system 102 and a client device 104. Although a single instance of server system 102 and client device 104 are shown, multiple instances of server system 102 and client device 104 may be appreciated. For example, multiple client devices 104 may be requesting content from a single server system 102 or multiple server systems 102.

Server system 102 includes a content management system 106 that may facilitate the delivery of content to client device 104. For example, content management system 106 may communicate with multiple content delivery networks (not shown) to have content delivered to multiple client devices 104. A content delivery network includes servers that can deliver content to client device 104. In some embodiments, the content delivery network delivers segments of video to client device 104. The segments may be a portion of the video, such as six seconds of the video. A video may be encoded in multiple profiles that correspond to different levels, which may be different levels of bitrates or quality (e.g., resolution). Client device 104 may request a segment of video from one of the profile levels based on current network conditions. For example, client device 104 may use an adaptive bitrate algorithm to select the profile for the video based on the estimated current available bandwidth and other network conditions.

Client device 104 may include a mobile phone, smartphone, set top box, television, living room device, tablet device, or other computing device. Client device 104 may include a media player 110 that is displayed on an interface 112. Media player 110 or client device 104 may request content from the content delivery network. In some embodiments, the content may be video, audio, or other content. Media player 110 may use an adaptive bitrate system to select a profile when requesting segments of the content. In response, the content delivery network may deliver (e.g., stream) the segments in the requested profiles to client device 104 for playback using media player 110.

Interface 112 may display images that may have been cropped. For example, the cropped images may represent instances of content that can be selected on interface 112 for playback in media player 110. In some embodiments, input images for the instances of content may be cropped into cropped images for display in interface 112. In other embodiments, the cropped images may be used for other purposes. For example, cropped images may be generated for websites, physical media, video playback, etc.

An image cropping system 108 may receive images. For example, images may be input that require cropping. In some examples, images for a content management system 106 that are going to be displayed on interface 112 are input for cropping. In the image cropping process, image cropping system 108 may use a set of anchor boxes to crop the images. Anchor boxes may be a set of predefined shapes that are used to predict potential areas to crop the image. Image cropping system 108 may generate a score for respective anchor boxes based on the input image. The score may be based on a metric, such as an intersection over union metric or other metrics. Image cropping system 108 may rank respective anchor boxes based on the scores, and select a highest ranked anchor box. The selected anchor box is then used to crop the image.

The following will describe the process of cropping images in more detail. Anchor boxes will be described followed by the training process and then the image cropping process.

### Anchor Boxes

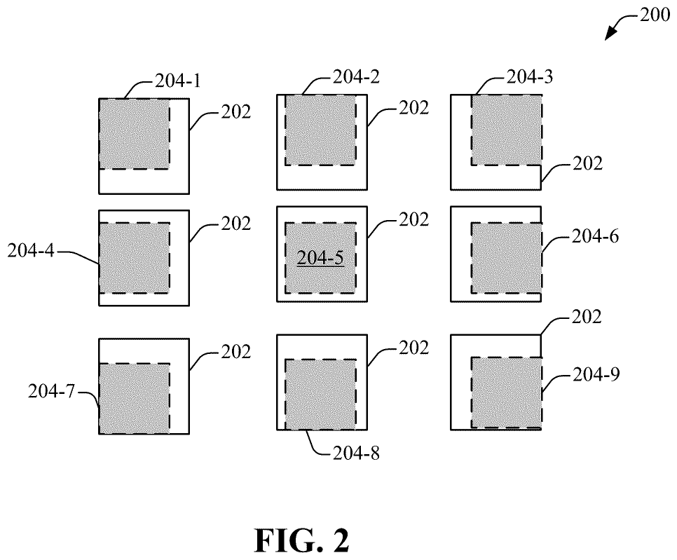

FIG. 2 depicts an example 200 of a set of anchor boxes according to some embodiments. As discussed above, anchor boxes may be predefined shapes that may be potential areas to crop an image. The anchor boxes may include coordinates that are within a portion of an image 202. For example, FIG. 2 shows nine anchor boxes 204-1 to 204-9 (collectively “204”) with shading and dashed lines. Other numbers of anchor boxes may be used, such as there may be three anchor boxes, six anchor boxes, ten anchor boxes, fifteen anchor boxes, etc. Anchor boxes 204 may be different shapes depending on the desired area that should be cropped. Although a “box” is used in the element “anchor box”, an anchor box may be shapes other than boxes. In this example, anchor boxes 204 are square shaped, but other anchor shapes such as rectangular, oval, circular, etc. may be used. Anchor boxes may be used for discussion purposes, but any anchor shapes may be used. Anchor boxes 204 may be represented by coordinates with respect to image 202. For example, the top left coordinates (x,y) and the bottom right coordinates (x,y) (or top right and bottom left coordinates) may be used to define the boundaries of an anchor box 204 within image 202. That is, a square or rectangle can be drawn using the two x,y coordinates. Other ways of defining the boundaries may be used, such as all four corners of a square, an x,y center point and a radius if anchor box 204 is a circle, or any other coordinates that are needed to define a shape.

Anchor boxes 204 are a portion of image 202. For example, an anchor box 204-1 is shown in the top left corner of image 202. If anchor box 204-1 is used to crop image 202, then the content within anchor box 204-1 is used as the cropped image and the content outside of anchor box 204-1 is not used. In a different example, anchor box 204-3 is found in the top right corner of image 202. Anchor box 204-3 may result in a cropped image that includes different content (e.g., the top right corner content) than the cropped image from anchor box 204-1. Each anchor box 204 may cover a different portion of content in image 202. Thus, anchor boxes 204-1 to 204-9 may crop image 202 differently.

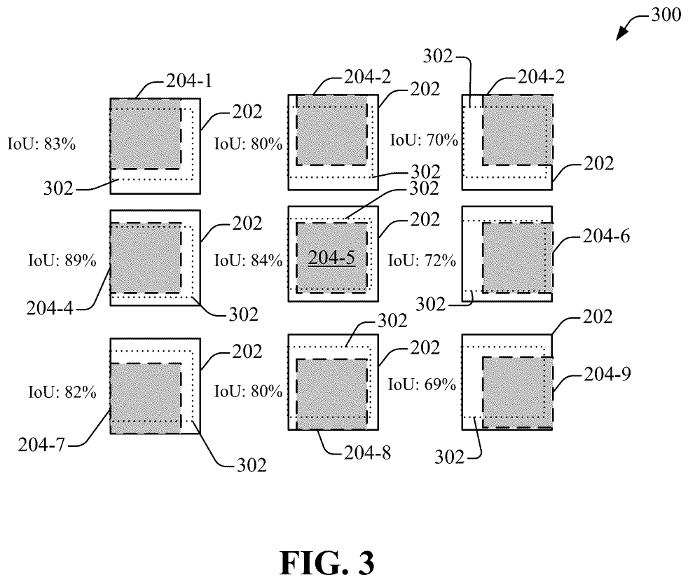

A metric may be used to rank the quality of the cropped image that results from using the anchor boxes. FIG. 3 depicts an example 300 of using a metric to generate scores for anchor boxes 204 according to some embodiments. The set of anchor boxes 204-1 to 204-9 are shown in FIG. 3 with shading and dashed lines.

A ground truth labeled box 302 is shown with dotted lines as the ground truth for cropping image 202. Labeled box 302 may be different shapes, such as boxes, circles, rectangles, etc. Labeled boxes may be used for discussion purposes, but any labeled shapes may be used. That is, the coordinates of labeled box 302 may be labeled as the ground truth cropped image for image 202. In some embodiments, a human user may label image 202 with labeled box 302. A difference between the labeled box 302 and respective anchor box 204 may be used to generate the metric. As discussed above, the metric of intersection over union may be used to measure the overlap of anchor box 202 and labeled box 302. A higher metric score may indicate the respective anchor box 204 overlaps more with labeled box 302. As can be seen, anchor box 204-4 has the highest metric score of IoU=89%. That is, anchor box 204-4 may overlap with labeled box 302 with the highest percentage of content. Other anchor boxes may have lower metric scores, such as anchor box 204-9 may have a metric score of 69%. As can be seen, the content of anchor box 204-9 may overlap with labeled box 302 less than anchor box 204-4 and other anchor boxes. Other metrics may be used, such as metrics that may rate a quality of the cropped image.

Image cropping system 108 may be trained to output scores for the metric. The following describes a training method to train a model of image cropping system 108.

### Training

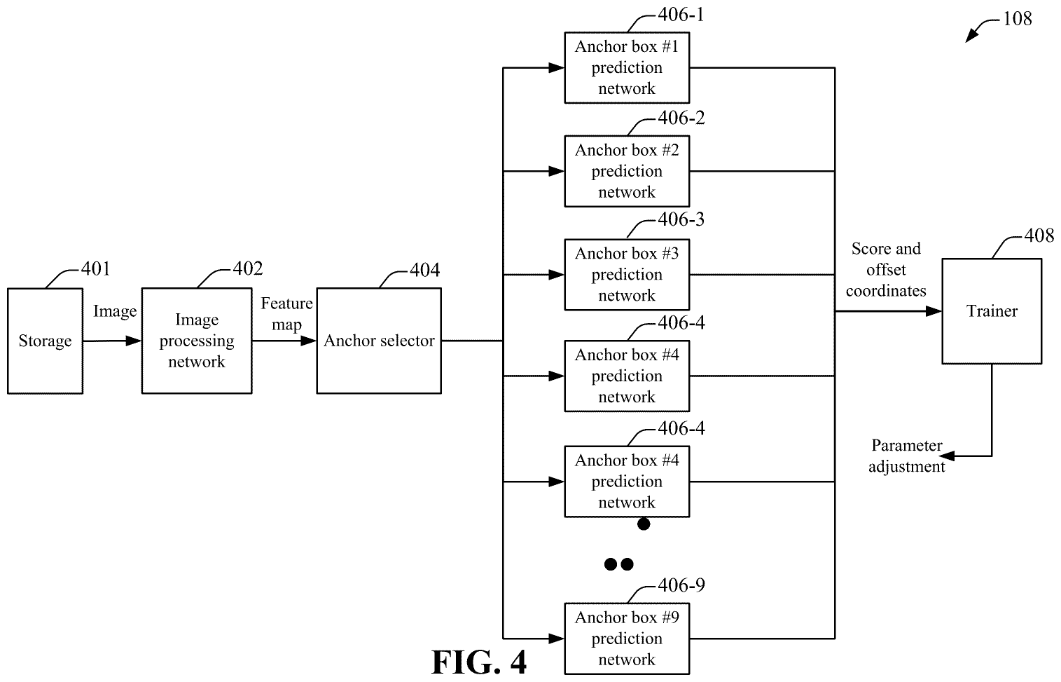

FIG. 4 depicts an example of image cropping system 108 for training a model for generating scores according to some embodiments. In some embodiments, the model may be based on different components that are used to generate an output for an image. The model includes parameters that can be adjusted during the training process. In some embodiments, the model includes an image processing network 402 and anchor box prediction networks 406. However, other components may be used, and are described below.

An image processing network 402 receives an image from storage 401 that is to be cropped. As discussed above, images may be input, such as images that are to be cropped for interface 112, or for other purposes. Image processing network 402 may analyze features of the image and generate a representation for the image. For example, image processing network 402 may include a convolution neural network (CNN) that receives an image and outputs a feature map for multiple channels. Each channel in a feature map may correspond to different aspects or characteristics of the image. For example, one channel may represent edges in various orientations of the image, another channel may represent textures, and another channel may represent color contrast. The feature map is extracted from the image using the convolutional neural network.

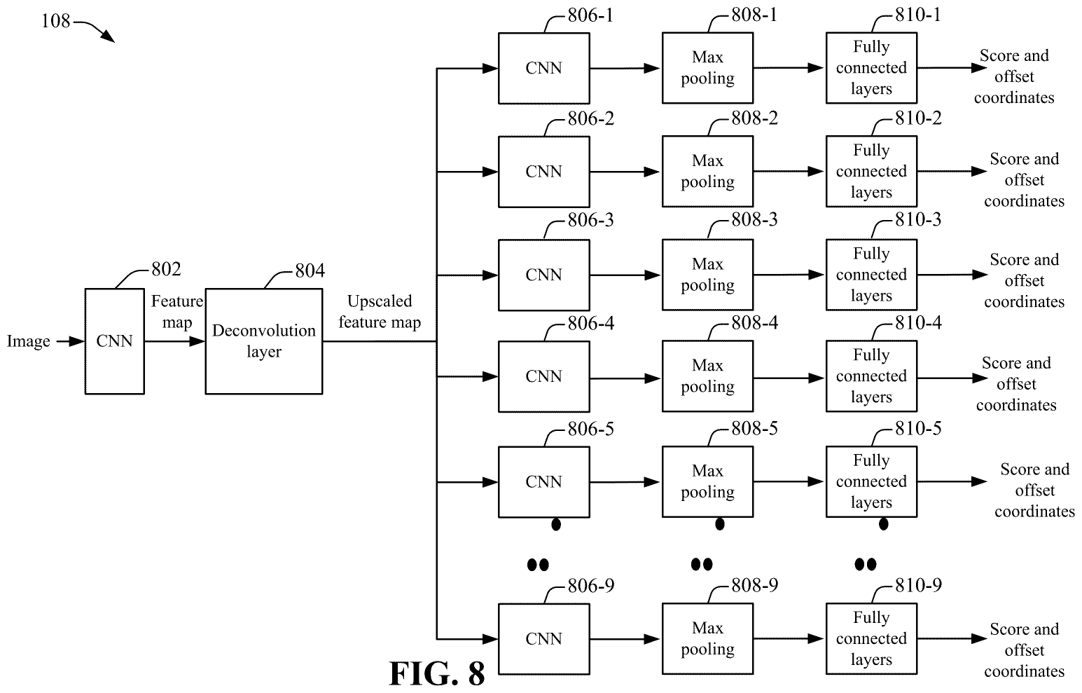

An anchor selector 404 may select an anchor box 204 to train. For example, each anchor box 204 may be associated with an anchor box prediction network 406. As shown, nine anchor box prediction networks 406-1 to 406-9 (collectively “406”) are shown, which are associated with anchor boxes 204-1 to 204-9, respectively. Respective prediction networks 406 for anchor boxes 204 may be trained. In some embodiments, parameters for a single prediction network 406 for a single anchor box may be trained at one time. Prediction network 406 may be implemented using different neural networks. For example, FIG. 8 describes an embodiment that uses a convolutional neural network, max pooling layer, and fully connected layers may be used. In general, prediction network 406 includes parameters that can be trained to output a score and offset coordinates based on receiving a feature map. Also, parameters for sets of anchor boxes 204 may be trained together. For example, anchor selector 404 may select a first anchor box prediction network 406-1 to train, which is associated with an anchor box 204-1. After training the first anchor box prediction network 406-1, anchor select 404 may select a second anchor box prediction network 406-2 to train.

Anchor box prediction networks 406 may include parameters that may be adjusted. Each anchor box prediction network 406 may generate an output based on analyzing the feature map. For example, the characteristics of the feature map in multiple channels may be mapped to the output based parameter values. In some embodiments, the output may be a score and offset coordinates. In other embodiments, an anchor box prediction network 406 may output only a score or only offset coordinates. The score may be based on the metric as described above in FIG. 3, such as an intersection over union score for the respective anchor box that is associated with the anchor box prediction network 406. The offset coordinates may be adjustments to the coordinates of the anchor box. The offset coordinates may be used to adjust the area that is cropped in the image based on the coordinates of the respective anchor box.

In some embodiments, each anchor box prediction network 406-1 to 406-9 may be trained to analyze a portion of content of the image that corresponds to the respective anchor box 204. For example, each anchor box prediction network 406-1 to 406-9 may analyze the content shown in FIG. 2 in the shaded boxes, and not content outside of respective anchor boxes 204. This may reduce the amount of content that is analyzed by anchor box prediction networks 406-1 to 406-9 and improve the speed of the training. Although content is discussed, as described, anchor box prediction networks 406-1 to 406-9 analyze the feature map. The feature map is generated by image processing network 402, such as via convolution operations. The convolution operations may generate features that include information from outside of the anchor box area. However, the features inside of a respective anchor box may only be analyzed by a respective anchor box prediction network 406. [In other embodiments, each anchor box prediction network 406-1 to 406-9 may analyze all the content in the image to generate an output for the training.

A trainer 408 may receive the output, such as the score and offset coordinates, and compare the output to a ground truth, such as a ground truth score and ground truth offset coordinates that are determined based on the labeled box 302. The difference between the outputted score and offset coordinates and the ground truth score and ground truth offset coordinates may be used to adjust parameters of the model. For example, a loss is determined based on the difference. Then, trainer 408 adjusts parameters in image processing network 402, anchor box prediction network 406, or any combination thereof based on the loss. The parameter adjustment may attempt to adjust parameters such that the outputted score and offset coordinates are closer to the ground truth score and ground truth offset coordinates. As will be described in more detail, image processing network 402 and anchor box prediction network 406 may include different components that are not described in FIG. 4. Parameters for any components that are used to generate the output for an image may be adjusted.

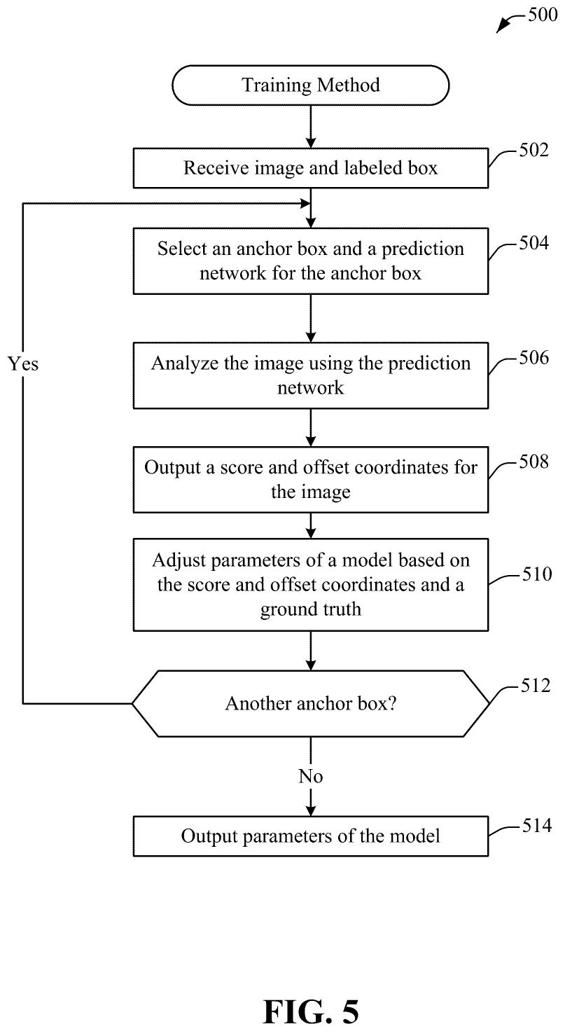

FIG. 5 depicts a simplified flow chart 500 of a method for training a model to generate scores and offset coordinates according to some embodiments. At 502, image processing network 402 receives an image and trainer 408 receives a labeled box 302 for the image. Trainer 408 may use the labeled box 302 to determine a ground truth score and ground truth offset coordinates for respective anchor boxes. Also, instead of receiving a labeled box 302, the ground truth score and offset coordinates may be received.

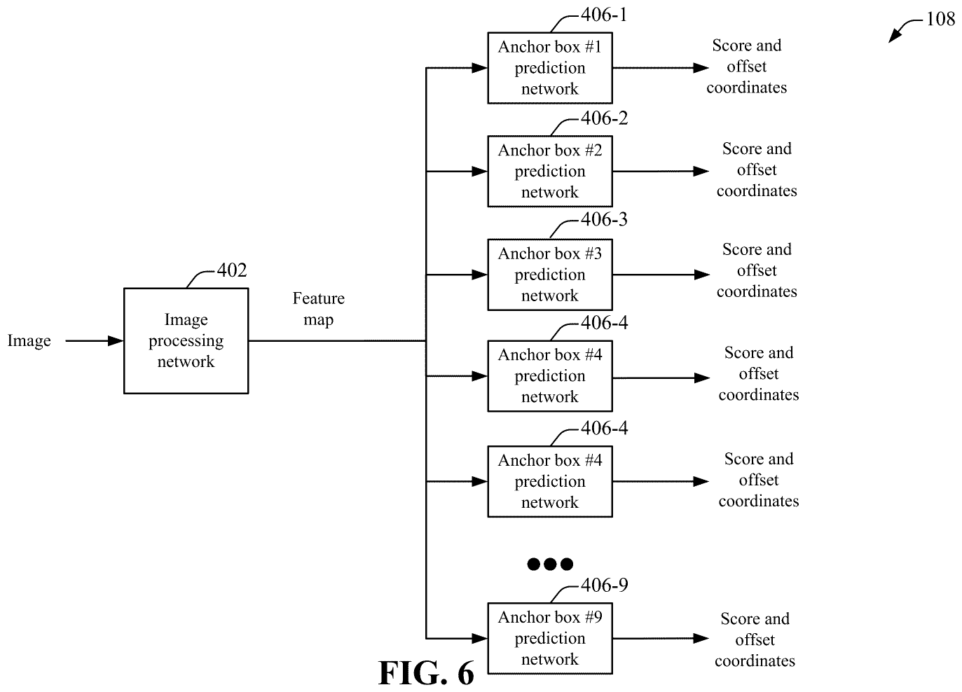

At 504, anchor selector 404 selects an anchor box 204 and an anchor box prediction network 406 for the anchor box. As described above, different anchor boxes 204 may be selected for training. For example, a single anchor box 204 is selected for training. At 506, the anchor box prediction network 406 is used to analyze the image. At 508, the anchor box prediction network 406 outputs a score and offset coordinates for the image. Details on generating the output are discussed in FIGS. 6 to 8. Anchor box prediction network 406 generates the output similarly in the training process using the parameter values that are being trained.

At 510, trainer 408 adjust parameters of the prediction network based on the outputted score and offset coordinates and the ground truth score and ground truth offset coordinates that are determined from the labeled box 302. As described above, a difference between the outputted score and the ground truth score and the outputted offset coordinates and ground truth offset coordinates may be used to adjust parameters.

At 512, it is determined whether another anchor box 204 should be selected. If so, the process reiterates to 504 where another anchor box 204 is selected and an anchor box prediction network 406 for that anchor box 204 is trained. This process may continue to train models for different anchor boxes 204. When no other anchor box 204 is selected, at 514, parameters of the model are output. The parameters that may be output may be parameters that were adjusted for image processing network 402 or various anchor box prediction networks 406.

Once the model is trained, the model may be used to crop images.

### Image Cropping

FIG. 6 depicts an example of image cropping system 108 for cropping an image according to some embodiments. The system in FIG. 6 is similar to the system that was used in FIG. 4, but may not use anchor selector 404. In this example, scores for all anchor boxes may be generated. If only a subset of scores are generated, then anchor selector 404 may be used to select anchor box prediction networks 406 to use. For example, a user preference may specify that only certain anchor box prediction networks 406 may be used when a subset of anchor boxes are desired to use for cropping an image.

In the process, image processing network 402 receives an image to crop. Image processing network 402 analyzes the image and outputs a feature map in multiple channels. As described above, parameters of image processing network 402 may have been trained to generate a feature map in multiple channels.

In this example, each anchor box prediction network 406-1 to 406-9 may be used to generate an output, such as a score and offset coordinates. Accordingly, the feature map may be input into anchor box prediction networks at 406-1 to 406-9. In other embodiments, a subset of anchor box prediction networks 406 may only be used.

Each anchor box prediction network 406-1 to 406-9 may analyze the feature map and generate an output of a respective score and respective offset coordinates. In some embodiments, each anchor box prediction network 406-1 to 406-9 may analyze a portion of the image that corresponds to its respective anchor box 204. For example, each anchor box prediction network 406-1 to 406-9 may analyze the features in anchor boxes shown in FIG. 2 in the shaded boxes, and not features outside of respective anchor boxes 204. This may reduce the amount of data that is analyzed by anchor box prediction networks 406-1 to 406-9 and improve the speed of the computation. Also, even though the features within an anchor box is analyzed, the features may include information from content outside of the anchor box, which may allow prediction network to generate an accurate score without needing to analyze the entire feature map. In other embodiments, each anchor box prediction network 406-1 to 406-9 may analyze all the content in the image to generate an output.

The anchor box 204 that is associated with the highest score may be selected as the anchor box to use to crop the image. If offset coordinates are being used, then the selected anchor box 204 may be adjusted by the offset coordinates to determine a shape to crop the image. In some embodiments, using the example, shown in FIG. 3, anchor box #4 prediction network 406-4 predicts a score of 89%, which is the highest score. Accordingly, the image is cropped using anchor box 204-4 to form a cropped image with content inside anchor box 204-4. Offset coordinates may be used to adjust anchor box 204-4 also. The adjusted coordinates may form a shape that is used to crop the image with content inside of the shape.

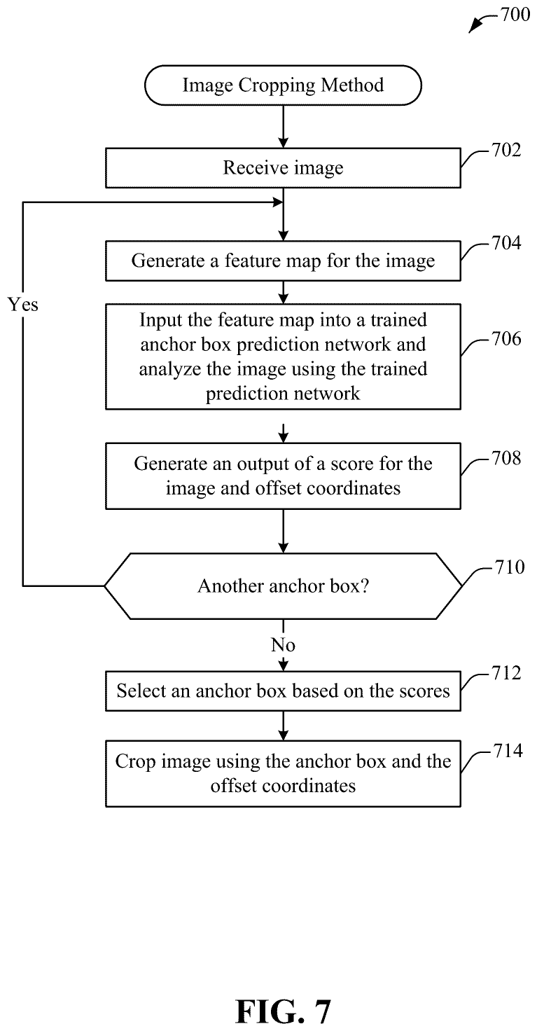

FIG. 7 depicts a simplified flow chart 700 of a method for cropping an image according to some embodiments. At 702, image processing network 402 receives an image. At 704, image processing network 402 generates a feature map for the image. As described above, parameters of image processing network 402 may have been trained to generate a feature map in multiple channels. It is noted that the following process may be performed in parallel with multiple anchor box prediction networks 406 generating scores even though it is described in series. At 706, the feature map is inputted into a trained anchor box prediction network 406, and anchor box prediction network 406 analyzes the image. Anchor box prediction network 406 may analyze the feature map and generate an output of a score and offset coordinates. In some embodiments, anchor box prediction network 406 may analyze a portion of the image that corresponds to its respective anchor box 204. At 708, anchor box prediction network 406 generates an output of a score for the image and offset coordinates. At 710, it is determined if another anchor box 204 should be analyzed. If another anchor box 204 should be analyzed, the process reiterates to 704. As discussed above, this process may be performed in parallel to generate output for each anchor box prediction network 406-1 to 406-9.

When all anchor boxes 204 have been analyzed, at 712, an anchor box 204 is selected based on its respective score. For example, the scores are ranked, and a highest ranked score may be selected. As mentioned above, anchor box 204-4 may be selected in the example described in FIG. 3.

At 714, the image is cropped using the anchor box and the offset coordinates. For example, the offset coordinates may be a first x,y coordinate for one corner of a box and a second x,y coordinate for an opposite corner of a box, such as the top left corner and the bottom right corner of a box or the bottom left corner and the top right corner of a box. The offset coordinates may be used to adjust the coordinates of the anchor box. For example, the top left corner of anchor box 204-4 is adjusted by the x,y coordinates of the first offset coordinates and the bottom right coordinates of anchor box 204-4 are adjusted by the x,y coordinates of the bottom right offset coordinates. This forms a new adjusted anchor box. Content within the new adjusted anchor box is then cropped to form the cropped image. In some examples, the bottom left of anchor box 204-4 may be the [0,0] coordinate in an X-Y dimensional space. Anchor box 204-4 may have top left coordinates of [0,100] and the offset coordinates are [1,3]. The new top left coordinates may be [1, 103]. Also, anchor box 204-4 may have bottom right coordinates of [100, 10] and the offset coordinates are [3,4]. The new bottom right coordinates may be [103, 14]. The image may be cropped using a box that is generated using the [1,103] and [103,14] coordinates.

Different models may be used to generate the score and offsets coordinates. FIG. 8 depicts an example of image cropping system 108 for generating scores and offset coordinates according to some embodiments. In some embodiments, image processing network 402 may include a convolutional neural network (CNN) 802 and a deconvolutional layer 804; and anchor box prediction networks 406 may include convolutional neural networks 806-1 to 806-9 (collectively “806”), max pooling layers 808-1 to 808-9, and fully connected layers 810-1 to 810-9 (collectively “810”).

An image is received at CNN 802. CNN 802 analyzes the image and generates a feature map of multiple channels. CNN 802 performs convolution operations on the pixels of the image. The convolution operations capture characteristics of the image, such as different patterns or features. The feature map includes channels that include values representing the presence or intensity of a specific characteristic in the image.

A deconvolutional layer 804 may upscale the feature map into an upscaled feature map. For example, deconvolution layer 804 may rescale the feature maps output by CNN 802 to the same scale of the input image. The upscaling may be used such that the positional information of the original image is preserved by the feature map. That is, features in the feature map are in the same positions as the features they represent in the image.

The upscaled feature map is input into convolutional neural networks 806-1 to 806-9 for respective anchor boxes 204. Each CNN 806 extracts features from the upscaled feature map. For example, the feature map in multiple channels is analyzed. Max pooling layers 808-1 to 808-9 may reduce the spatial resolution of the feature maps while retaining the most important information. Then, fully connected layers 810-1 to 810-9 analyze the feature map to generate output, such as the respective score and offset coordinates. Fully connected layers 810 may have learned the relationships of characteristics of feature maps to generate respective scores and offset coordinates.

During the training process, parameters of any of the components described in FIG. 8 may be adjusted. Also, although the above components are described as being used to generate the score and offset coordinates, different components may be used.

### Conclusion

Accordingly, the use of anchor boxes 204 may improve the cropping of images. The use of anchor boxes 204 may reduce the computing resources that are used to analyze images and to crop the images. For example, the anchor boxes 204 may analyze less content of the image. Further, generating the score may require fewer computing resources than generating the coordinates of the bounding box to use to crop the image directly. Also, the training of the model that is used to crop the images may be more efficient. The training of a model to output the score instead of outputting the coordinates of the bounding box directly for the cropped image may require less images due to the prediction being less complicated. The training may result in optimal cropped images.

### System

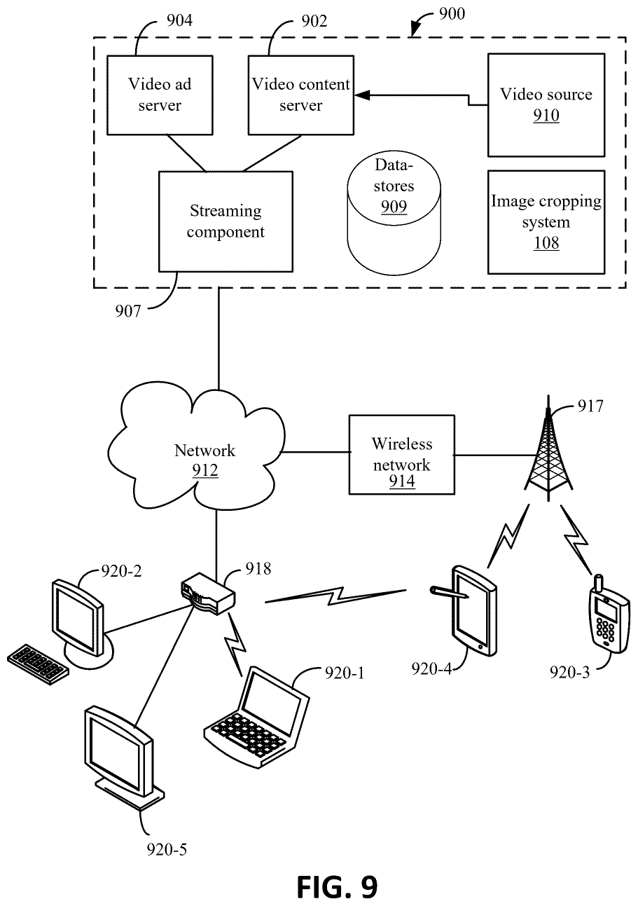

Features and aspects as disclosed herein may be implemented in conjunction with a video streaming system 900 in communication with multiple client devices via one or more communication networks as shown in FIG. 9. Aspects of the video streaming system 900 are described merely to provide an example of an application for enabling distribution and delivery of content prepared according to the present disclosure. It should be appreciated that the present technology is not limited to streaming video applications and may be adapted for other applications and delivery mechanisms.

In one embodiment, a media program provider may include a library of media programs. For example, the media programs may be aggregated and provided through a site (e.g., website), application, or browser. A user can access the media program provider's site or application and request media programs. The user may be limited to requesting only media programs offered by the media program provider.

In system 900, video data may be obtained from one or more sources for example, from a video source 910, for use as input to a video content server 902. The input video data may comprise raw or edited frame-based video data in any suitable digital format, for example, Moving Pictures Experts Group (MPEG)-1, MPEG-2, MPEG-4, VC-1, H.264/Advanced Video Coding (AVC), High Efficiency Video Coding (HEVC), or other format. In an alternative, a video may be provided in a non-digital format and converted to digital format using a scanner or transcoder. The input video data may comprise video clips or programs of various types, for example, television episodes, motion pictures, and other content produced as primary content of interest to consumers. The video data may also include audio or only audio may be used.

The video streaming system 900 may include one or more computer servers or modules 902, 904, and 907 distributed over one or more computers. Each server 902, 904, 907 may include, or may be operatively coupled to, one or more data stores 909, for example databases, indexes, files, or other data structures. A video content server 902 may access a data store (not shown) of various video segments. The video content server 902 may serve the video segments as directed by a user interface controller communicating with a client device. As used herein, a video segment refers to a definite portion of frame-based video data, such as may be used in a streaming video session to view a television episode, motion picture, recorded live performance, or other video content.

In some embodiments, a video advertising server 904 may access a data store of relatively short videos (e.g., 10 second, 30 second, or 60 second video advertisements) configured as advertising for a particular advertiser or message. The advertising may be provided for an advertiser in exchange for payment of some kind or may comprise a promotional message for the system 900, a public service message, or some other information. The video advertising server 904 may serve the video advertising segments as directed by a user interface controller (not shown).

The video streaming system 900 also may include image cropping system 108.

The video streaming system 900 may further include an integration and streaming component 907 that integrates video content and video advertising into a streaming video segment. For example, streaming component 907 may be a content server or streaming media server. A controller (not shown) may determine the selection or configuration of advertising in the streaming video based on any suitable algorithm or process. The video streaming system 900 may include other modules or units not depicted in FIG. 9, for example, administrative servers, commerce servers, network infrastructure, advertising selection engines, and so forth.

The video streaming system 900 may connect to a data communication network 912. A data communication network 912 may comprise a local area network (LAN), a wide area network (WAN), for example, the Internet, a telephone network, a wireless network 914 (e.g., a wireless cellular telecommunications network (WCS)), or some combination of these or similar networks.

One or more client devices 920 may be in communication with the video streaming system 900, via the data communication network 912, wireless network 914, or another network. Such client devices may include, for example, one or more laptop computers 920-1, desktop computers 920-2, “smart” mobile phones 920-3, tablet devices 920-4, network-enabled televisions 920-5, or combinations thereof, via a router 918 for a LAN, via a base station 917 for wireless network 914, or via some other connection. In operation, such client devices 920 may send and receive data or instructions to the system 900, in response to user input received from user input devices or other input. In response, the system 900 may serve video segments and metadata from the data store 909 responsive to selection of media programs to the client devices 920. Client devices 920 may output the video content from the streaming video segment in a media player using a display screen, projector, or other video output device, and receive user input for interacting with the video content.

Distribution of audio-video data may be implemented from streaming component 907 to remote client devices over computer networks, telecommunications networks, and combinations of such networks, using various methods, for example streaming. In streaming, a content server streams audio-video data continuously to a media player component operating at least partly on the client device, which may play the audio-video data concurrently with receiving the streaming data from the server. Although streaming is discussed, other methods of delivery may be used. The media player component may initiate play of the video data immediately after receiving an initial portion of the data from the content provider. Traditional streaming techniques use a single provider delivering a stream of data to a set of end users. High bandwidth and processing power may be required to deliver a single stream to a large audience, and the required bandwidth of the provider may increase as the number of end users increases.

Streaming media can be delivered on-demand or live. Streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities via a specialized device that accepts requests for video files, and with information about the format, bandwidth, and structure of those files, delivers just the amount of data necessary to play the video, at the rate needed to play it. Streaming media servers may also account for the transmission bandwidth and capabilities of the media player on the destination client. Streaming component 907 may communicate with client device 920 using control messages and data messages to adjust to changing network conditions as the video is played. These control messages can include commands for enabling control functions such as fast forward, fast reverse, pausing, or seeking to a particular part of the file at the client.

Since streaming component 907 transmits video data only as needed and at the rate that is needed, precise control over the number of streams served can be maintained. The viewer will not be able to view high data rate videos over a lower data rate transmission medium. However, streaming media servers (1) provide users random access to the video file, (2) allow monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming component 907 may use TCP-based protocols, such as HyperText Transfer Protocol (HTTP) and Real Time Messaging Protocol (RTMP). Streaming component 907 can also deliver live webcasts and can multicast, which allows more than one client to tune into a single stream, thus saving bandwidth. Streaming media players may not rely on buffering the whole video to provide random access to any point in the media program. Instead, this is accomplished using control messages transmitted from the media player to the streaming media server. Other protocols used for streaming are HTTP live streaming (HLS) or Dynamic Adaptive Streaming over HTTP (DASH). The HLS and DASH protocols deliver video over HTTP via a playlist of small segments that are made available in a variety of bitrates typically from one or more content delivery networks (CDNs). This allows a media player to switch both bitrates and content sources on a segment-by-segment basis. The switching helps compensate for network bandwidth variances and infrastructure failures that may occur during playback of the video.

The delivery of video content by streaming may be accomplished under a variety of models. In one model, the user pays for the viewing of video programs, for example, paying a fee for access to the library of media programs or a portion of restricted media programs, or using a pay-per-view service. In another model widely adopted by broadcast television shortly after its inception, sponsors pay for the presentation of the media program in exchange for the right to present advertisements during or adjacent to the presentation of the program. In some models, advertisements are inserted at predetermined times in a video program, which times may be referred to as “ad slots” or “ad breaks.” With streaming video, the media player may be configured so that the client device cannot play the video without also playing predetermined advertisements during the designated ad slots.

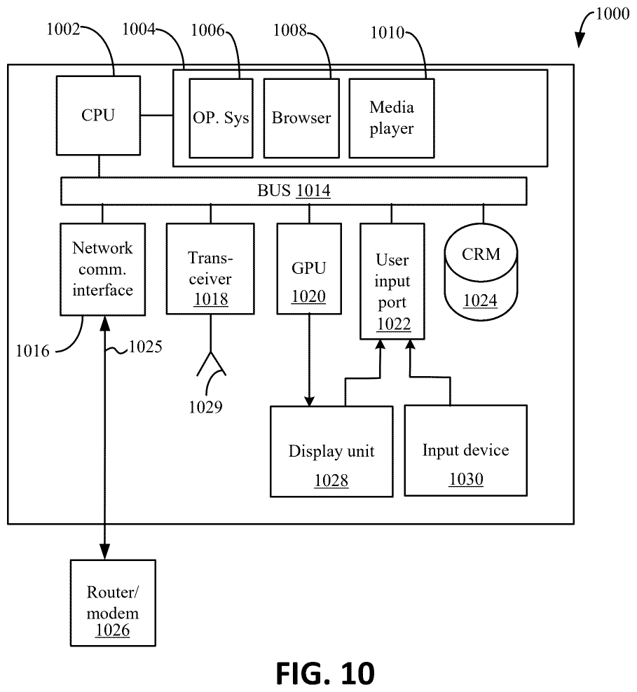

Referring to FIG. 10, a diagrammatic view of an apparatus 1000 for viewing video content and advertisements is illustrated. In selected embodiments, the apparatus 1000 may include a processor (CPU) 1002 operatively coupled to a processor memory 1004, which holds binary-coded functional modules for execution by the processor 1002. Such functional modules may include an operating system 1006 for handling system functions such as input/output and memory access, a browser 1008 to display web pages, and media player 1010 for playing video. The memory 1004 may hold additional modules not shown in FIG. 10, for example modules for performing other operations described elsewhere herein.

A bus 1014 or other communication components may support communication of information within the apparatus 1000. The processor 1002 may be a specialized or dedicated microprocessor configured or operable to perform particular tasks in accordance with the features and aspects disclosed herein by executing machine-readable software code defining the particular tasks. Processor memory 1004 (e.g., random access memory (RAM) or other dynamic storage device) may be connected to the bus 1014 or directly to the processor 1002, and store information and instructions to be executed by a processor 1002. The memory 1004 may also store temporary variables or other intermediate information during execution of such instructions.

A computer-readable medium in a storage device 1024 may be connected to the bus 1014 and store static information and instructions for the processor 1002; for example, the storage device (CRM) 1024 may store the modules for operating system 1006, browser 1008, and media player 1010 when the apparatus 1000 is powered off, from which the modules may be loaded into the processor memory 1004 when the apparatus 1000 is powered up. The storage device 1024 may include a non-transitory computer-readable storage medium holding information, instructions, or some combination thereof, for example instructions that when executed by the processor 1002, cause the apparatus 1000 to be configured or operable to perform one or more operations of a method as described herein.

A network communication (comm.) interface 1016 may also be connected to the bus 1014. The network communication interface 1016 may provide or support two-way data communication between the apparatus 1000 and one or more external devices, e.g., the streaming system 900, optionally via a router/modem 1026 and a wired or wireless connection 1025. In the alternative, or in addition, the apparatus 1000 may include a transceiver 1018 connected to an antenna 1029, through which the apparatus 1000 may communicate wirelessly with a base station for a wireless communication system or with the router/modem 1026. In the alternative, the apparatus 1000 may communicate with a video streaming system 900 via a local area network, virtual private network, or other network. In another alternative, the apparatus 1000 may be incorporated as a module or component of the system 900 and communicate with other components via the bus 1014 or by some other modality.

The apparatus 1000 may be connected (e.g., via the bus 1014 and graphics processing unit 1020) to a display unit 1028. A display 1028 may include any suitable configuration for displaying information to an operator of the apparatus 1000. For example, a display 1028 may include or utilize a liquid crystal display (LCD), touchscreen LCD (e.g., capacitive display), light emitting diode (LED) display, projector, or other display device to present information to a user of the apparatus 1000 in a visual display.

One or more input devices 1030 (e.g., an alphanumeric keyboard, microphone, keypad, remote controller, game controller, camera, or camera array) may be connected to the bus 1014 via a user input port 1022 to communicate information and commands to the apparatus 1000. In selected embodiments, an input device 1030 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 1028, for example using a touch sensitive screen. A cursor control device may communicate direction information and command selections to the processor 1002 and control cursor movement on the display 1028. A cursor control device may have two or more degrees of freedom, for example allowing the device to specify cursor positions in a plane or three-dimensional space.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving an image;
analyzing the image based on a plurality of anchor shapes to generate respective outputs for anchor shapes in the plurality of anchor shapes, wherein the output rates a cropping of the image using a respective anchor shape;
analyzing respective outputs for the anchor shapes in the plurality of anchor shapes to select an anchor shape; and
cropping the image using the anchor shape.

2. The method of claim 1, wherein anchor shapes in the plurality of anchor shapes crop different portions of the image.

3. The method of claim 1, wherein anchor shapes in the plurality of anchor shapes are predefined shapes.

4. The method of claim 1, wherein analyzing the image comprises:
generating a feature map from the image, wherein the feature map represents one or more characteristics of the image; and
analyzing the feature map to generate respective outputs for the anchor shapes.

5. The method of claim 4, wherein:
the feature map comprises multiple channels, wherein channels are associated with characteristics of the image, and
the channels are analyzed to generate the output.

6. The method of claim 1, wherein analyzing the image comprises:
analyzing the image using a plurality of prediction networks, wherein prediction networks in the plurality of prediction networks are associated with respective anchor shapes in the plurality of anchor shapes.

7. The method of claim 6, wherein each prediction network is associated with an anchor shape in the plurality of anchor shapes and generates an output based on the respective anchor shape.

8. The method of claim 6, wherein each prediction network analyzes information from the image based on the respective anchor shape to generate the output.

9. The method of claim 6, wherein each prediction network analyzes information that is within the respective anchor shape and not outside of the respective anchor shape to generate the output.

10. The method of claim 9, wherein the information comprises a portion of a feature map that represents one or more characteristics of the image.

11. The method of claim 1, wherein the output represents a score for an overlap of a respective anchor shape and a preferred cropped image.

12. The method of claim 1, further comprising:
analyzing the image based on the plurality of anchor shapes to generate offset coordinates for anchor shapes in the plurality of anchor shapes, wherein the offset coordinates are used to crop the image.

13. The method of claim 12, wherein:
the offset coordinates adjust coordinates of the anchor shape to generate adjusted coordinates, and
the adjusted coordinates are used to crop the image.

14. The method of claim 1, further comprising:
training a model for the plurality of anchor shapes using a training image, wherein parameters of the model are adjusted using a comparison of a first output for an anchor shape to a second output that is based on a labeled shape for the training image.

15. The method of claim 14, wherein training comprises:
receiving the training image and the labeled shape;
generating the first output using the model for the anchor shape;
determining the second output, wherein the second output is based on an overlap of the labeled shape and the anchor shape; and
comparing the first output and the second output, wherein a difference between the first output and the second output is used to adjust the parameters of the model.

16. The method of claim 15, wherein training comprises:
generating first outputs using the model for anchor shapes in the plurality of anchor shapes;
determining second outputs, wherein the second outputs are based on an overlap of the labeled shape and the respective anchor shapes; and
comparing the respective first outputs and the respective second outputs, wherein a difference between the respective first outputs and the respective second outputs is used to adjust the parameters of the model for the anchor shapes.

17. The method of claim 1, wherein:
the anchor shape is a shape that is defined by coordinates, and
the coordinates are used to crop the image.

18. A non-transitory computer-readable storage medium having stored thereon computer executable instructions, which when executed by a computing device, cause the computing device to be operable for:
receiving an image;
analyzing the image based on a plurality of anchor shapes to generate respective outputs for anchor shapes in the plurality of anchor shapes, wherein the output rates a cropping of the image using a respective anchor shape;
analyzing respective outputs for the anchor shapes in the plurality of anchor shapes to select an anchor shape; and
cropping the image using the anchor shape.

19. The non-transitory computer-readable storage medium of claim 18, wherein anchor shapes in the plurality of anchor shapes crop different portions of the image.

20. An apparatus comprising:
one or more computer processors; and
a computer-readable storage medium comprising instructions for controlling the one or more computer processors to be operable for:
receiving an image;
analyzing the image based on a plurality of anchor shapes to generate respective outputs for anchor shapes in the plurality of anchor shapes, wherein the output rates a cropping of the image using a respective anchor shape;
analyzing respective outputs for the anchor shapes in the plurality of anchor shapes to select an anchor shape; and
cropping the image using the anchor shape.
